(19) United States
(12) Patent Application Publication
(10) Pub. No.: US 2021/0341281 A1
(43) Pub. Date: Nov. 4, 2021

(54) METHOD AND MICROSCOPE FOR DETERMINING A TILT OF A COVER SLIP

(71) Applicant: LEICA MICROSYSTEMS CMS GMBH, Wetzlar (DE)

(72) Inventor: Christian SCHUMANN, Lich (DE)

(21) Appl. No.: 17/283,573

(22) PCT Filed: Oct. 11, 2019
(86) PCT No.: PCT/EP2019/077631

§ 371 Date: Apr. 8, 2021

(30) Foreign Application Priority Data
Oct. 19, 2018 (DE) 10 2018 125 995.6

(51) Int. Cl. G01B 11/02; G01B 11/26; G02B 21/24

(52) U.S. Cl. CPC G01B 11/026; G02B 21/0088; G02B 21/245; G01B 11/26

(57) ABSTRACT

A method for determining a tilting of a coverslip in a microscope, which has an object lens facing the coverslip, includes defining at least three measuring points which span a plane on a surface of the coverslip. The following steps are carried out for each of the measuring points: directing a measuring light beam through the object lens to the respective measuring point; producing a reflection light beam by at least partial reflection at the respective measuring point; directing the reflection light beam through the object lens onto a position-sensitive sensor and detecting an incidence position thereon; and determining a distance of the respective measuring point from the object lens along an optical axis thereof based on the detected incidence position. Based on the determined distances, a tilting of the plane spanned by the at least three measuring points relative to the optical axis is determined.

### CROSS-REFERENCE TO PRIOR APPLICATIONS

This application is a U.S. National Phase Application under 35 U.S.C. § 371 of International Application No. PCT/EP2019/077631, filed on Oct. 11, 2019, and claims benefit to German Patent Application No. DE 10 2018 125 995.6, filed on Oct. 19, 2018. The International Application was published in German on Apr. 23, 2020 as WO 2020/078854 under PCT Article 21(2).

### FIELD

The invention relates to a method for determining a tilting of a coverslip in a microscope, comprising an object lens facing the coverslip. The invention further relates to a microscope having a device for determining a tilting of a coverslip.

### BACKGROUND

The quality of a light microscopic image with the aid of an object lens with a high numerical aperture is strongly influenced by the position of a coverslip that covers the sample to be imaged. For example, the imaging error is induced by tilting the coverslip relative to the optical axis of the object lense. Tilting of the coverslip leads to the detection light used for imaging falling obliquely into the object lens. This produces a coma. In order to enable an effective correction of the coma caused by tilting of the coverslip, it is important to know the tilting as precisely as possible.

A measurement of the tilting of the coverslip can take place in a tactile way, i.e. with the aid of a measuring probe. However, this is associated with a high outlay on process engineering and requires the insertion of the measuring probe into the sample compartment.

For the state of the art, reference is further made to DE 10 2010 030 430 A1, in which an triangulating autofocus device for a microscope is disclosed. This autofocus device generates a slit image on the sample which is imaged onto a position-sensitive detector. The autofocus is controlled via the incident position detected by the detector.

### SUMMARY

In an embodiment, the present invention provides a method for determining a tilting of a coverslip in a microscope which has an object lens facing the coverslip. The method includes defining at least three measuring points which span a plane on a surface of the coverslip. The following steps are carried out for each of the at least three measuring points: directing a measuring light beam through the object lens to the respective measuring point; producing a reflection light beam by reflecting the measuring light beam at least partially at the respective measuring point; directing the reflection light beam through the object lens onto a position-sensitive sensor; detecting an incidence position of the reflection light beam on the position-sensitive sensor; and determining a distance of the respective measuring point from the object lens along an optical axis of the object lens based on the detected incidence position. Based on the determined distances, a tilting of the plane spanned by the at least three measuring points relative to the optical axis of the object lens is determined as a tilting of the surface of the coverslip.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically depicts an inverse transmitted light microscope as a first exemplary embodiment;

FIG. 2 shows a device for determining the tilting of the coverslip, which is part of the microscope according to FIG. 1;

FIG. 3 schematically depicts a sample compartment of the microscope according to FIG. 1;

FIG. 4 shows an intensity distribution detected by a position-sensitive detector of the device according to FIG. 2;

FIG. 5 schematically depicts a plane defined by three measuring points;

FIG. 6 is a flowchart showing a particular embodiment of the method according to the invention for determining the thickness of the coverslip;

FIG. 7 schematically depicts a displaceable microscope table; and

FIG. 8 schematically depicts an upright transmitted-light microscope which forms a second exemplary embodiment of the microscope according to the invention.

### DETAILED DESCRIPTION

Embodiments of the invention provide a method and a microscope which enables a tilting of a coverslip to be determined in a simple and precise manner.

The method according to an embodiment of the invention is used to determine a tilting of a coverslip in a microscope which has an object lens facing the coverslip. At least three measuring points, which span a plane, are defined on a surface of the coverslip. The following steps are carried out for each of the three measuring points: Directing a measuring light beam through the object lens onto the measuring point; generating a reflection light beam by at least partially reflecting the measuring light beam at the respective measuring point; guiding the reflection light beam through the object lens onto a position-sensitive sensor; detecting the incident position of the reflection light beam on the position-sensitive sensor; and establishing the distance of the respective measuring point from the object lens along its optical axis based on the detected incident position. A tilting of the plane spanned by the three measuring points relative to the optical axis of the object lens is determined as tilting of the surface of the coverslip on the basis of the determined distances.

According to an embodiment of the invention, it is assumed that the plane spanned by the at least three measuring points is coplanar with the surface of the coverslip mentioned. The tilting of this plane relative to the optical axis of the object lens therefore reflects the tilting of the coverslip. Each of the at least three measuring points is in each case determined by three coordinates, one of which indicates the distance of the measuring point to be determined from the object lens along its optical axis, while the other two coordinates define the position of the respective measuring point on the surface of the coverslip.

The method according to embodiments of the invention makes it possible to determine the tilting of the coverslip within the microscope in a simple and reliable manner.

In a preferred embodiment, the at least three measuring points are defined by moving the coverslip and the object lens transverse to its optical axis relative to one another. The determination of the measuring points can take place according to the specifications of an operator or automatically. For example, the dots may be defined while moving the coverslip to scan a specimen transverse to the optical axis of the object lens.

The coverslip is preferably moved relative to the object lens transverse to its optical axis by means of a movable microscope table.

In a particularly preferred embodiment, the measuring light beam is guided into a partial region of an entry pupil of the object lens which is offset from the center of the entry pupil. In this way, the entry pupil of the object lens is backlit decentrally by the measuring light beam, whereby the measuring light beam is set obliquely to its optical axis when exiting the object lens. The decentralized backlighting of the entry pupil of the object lens has the advantage that beam portions close to the axis are avoided, which cause so-called first-order reflections which occur most strongly at the surface shells of the lenses forming the lens and thereby impair the signal-to-noise ratio. The reflection light beam is preferably directed back into the object lens in such a way that, in the direction opposite to the propagation direction of the measuring light beam, it passes through another partial region of the entry pupil which is offset from the aforementioned partial region of the entry pupil.

It is advantageous if a measurement pattern is produced on the surface of the measuring light beam and the measurement pattern is imaged onto the position-sensitive sensor by the reflection light beam. It is thus possible, for example, to generate the measurement pattern in the form of an image of a slit diaphragm, which is arranged upstream of the light source emitting the measuring light beam.

In a preferred embodiment, the surface of the coverslip on which the measuring light beam is reflected to generate the reflection light beam forms a partially reflective boundary surface with an adjacent optical medium. In particular, the optical medium is an embedding medium which adjoins said surface of the coverslip.

In this embodiment, the distance measurement performed at the respective measuring point, on which the determination of the tilting of the coverslip according to an embodiment of the invention is based, utilizes partial reflection of the measuring light beam at the surface of the coverslip. This partial reflection is caused by the fact that the surface with the optical medium bordering it, which has a different refractive index than the coverslip, forms a boundary surface at which a jump in the refractive index occurs. In this way, it is possible to determine the tilting of the coverslip within the microscope in a particularly simple and reliable manner.

In a particularly preferred embodiment, the orientation of a normal vector which lies perpendicular to said plane is determined on the basis of the at least three measuring points. The tilting of the coverslip is then determined from this. In particular, the angle enclosed by the normal vector and the optical axis of the object lens can be determined. This angle makes it possible to clearly quantify the tilting of the plane defined by the measuring points and thus the tilting of the coverslip.

More than three measuring points are preferably defined, the distances of which are determined by the object lens for determining the tilting of the coverslip. The more measuring points are defined on the surface of the coverslip, the more precisely the tilting of the plane defined by the measuring points and thus the tilting of the coverslip can be determined.

In a preferred embodiment, the coverslip is adjusted to compensate for the tilting that was determined. Alternatively, the determined tilting can be used for calculating a filter function for inversion of the imaging process, for example a deconvolution or a quantitative phase reconstruction.

In another embodiment, the invention provides a microscope comprising a coverslip, an object lens facing the coverslip, and a device for determining a tilting of the coverslip. The device is designed to define at least three measuring points which span a plane on a surface of the coverslip and to carry out the following steps for each of these measuring points: Directing a measuring light beam through the object lens onto the measurement point; generating a reflection light beam by at least partially reflecting the measuring light beam at the respective measuring point, guiding the reflection light beam through the object lens onto a position-sensitive sensor; establishing the incident position of the reflection light beam on the position-sensitive sensor; and detecting the distance of the respective measuring point from the object lens along its optical axis based on the detected incident position. The device is further designed to determine a tilting of the plane spanned by the three measuring points relative to the optical axis of the object lens as tilting of the surface of the coverslip on the basis of the determined distances.

In a preferred embodiment, the device has an aperture diaphragm with an aperture opening which is arranged in a decentered manner at a distance from the optical axis of the object lens.

In a specific embodiment, the device has a light source which emits the measuring light beam in the infrared wavelength range. This has the advantage that the measurement pattern generated by the measuring light beam on the coverslip is not visible to the human eye and thus does not disturb the observation of the sample by the microscope. However, it is equally possible to use a measuring light beam in the visible wavelength range.

In a preferred embodiment, the position sensitive sensor is a line sensor. The line sensor is preferably designed in such a way that it can detect the intensity distribution of the reflection light beam in its entirety. Alternatively, the position-sensitive sensor can also be embodied as a surface sensor, for example as a two-dimensional CCD camera.

The microscope preferably comprises means for correcting the determined tilting of the coverslip. These means comprise, for example, a manually movable or motorized microscope table.

Due to its structural and functional properties described herein, the device according to an embodiment of the invention is also suitable for use as an autofocus device in the microscope. In addition, due to its properties, the device offers the possibility of determining, in addition to tilting the coverslip, other parameters influencing the light microscopic imaging, such as the thickness of the coverslip and/or the refractive index of an optical medium.

Embodiments of the invention can be applied to a plurality of microscope types, e.g. inverse or upright transmitted-light microscopes.

Further features and advantages of embodiments of the invention will become apparent from the following description, which explains in more detail exemplary embodiments in conjunction with the attached figures.

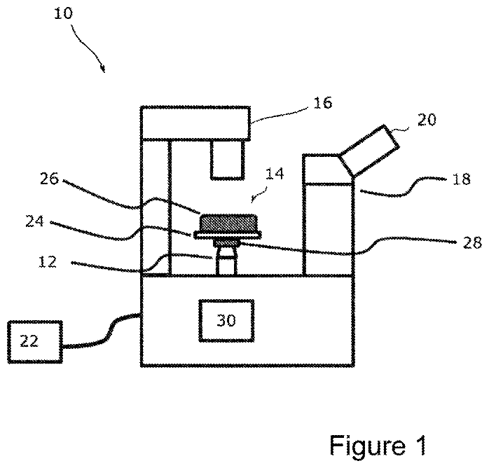

FIG. 1 shows a microscope 10 to which the tilt determination according to the invention is applicable as a first exemplary embodiment.

The microscope 10 is designed as an inverse transmitted-light microscope. Accordingly, it comprises an object lens 12 which faces from below a sample compartment provided with the reference numeral 14 in FIG. 1 and a light source 16 which is directed from above onto the sample compartment 14. The microscope 10 further has a tube 18 having an eyepiece 20 through which an operator may view a sample image captured by the object lens 12. In addition, a control unit 22 is provided that controls the various microscope components.

In the sample compartment 14 of the microscope 10 there is a coverslip 24 which covers a sample not explicitly shown in FIG. 1. On the coverslip 24 there is an optical medium 26 in which the sample is embedded and which is referred to hereinafter as embedding medium 26. Furthermore, an immersion medium 28 is arranged in the sample compartment 14 which in FIG. 1 is adjacent to the object lens 12 from above and to the coverslip 24 from below.

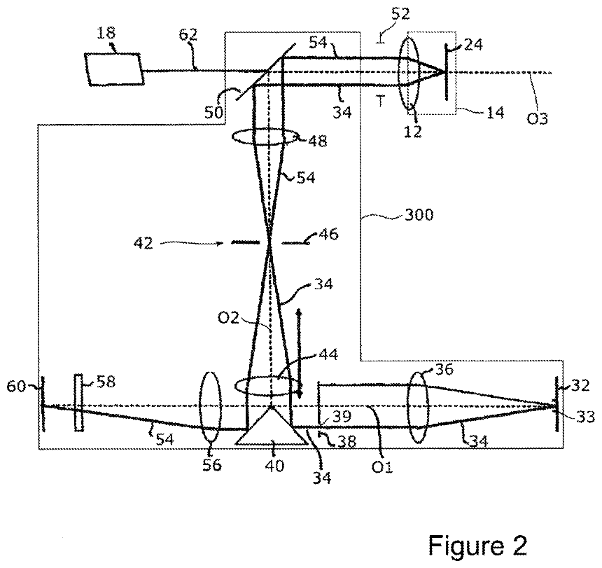

The microscope 10 furthermore has a device, generally designated by reference numeral 30 in FIG. 1, which serves to determine the tilting of the coverslip 14. The device 30 is shown in FIG. 2 in more detail.

As shown in FIG. 2, the device 30 has a light source 32 which emits a measuring light beam 34 in the infrared wavelength range. The light source 32 is, for example, an LED which has a slit diaphragm 33 through which the measuring light beam 34 is directed onto an illumination optics 36. After passing through the illumination optics 36, the measuring light beam 34 strikes an aperture diaphragm 38 which is positioned centrally on the optical axis O1 of the illumination optics 36 but has an aperture opening 39 which is arranged in a decentered manner at a distance from the optical axis O1 of the illumination optics 36. The aperture opening 39 of the aperture diaphragm 38 limits the beam cross section of the measuring light beam 34 in such a way that only the part of the measuring light beam 34 lying below the optical axis O1 of the illumination optics 36 in FIG. 2 passes through the aperture diaphragm 38 in the direction of a deflection prism 40.

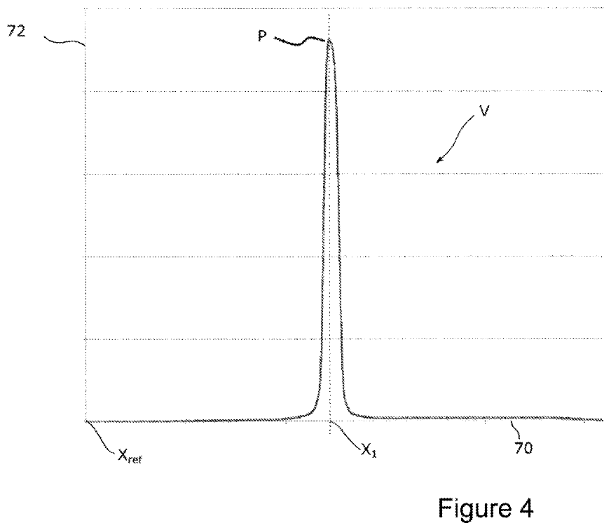

The measuring light beam 34 delimited in its beam cross section is reflected at the deflection prism 40 into transport optics 42 which are formed from a focusing lens 44 that can be displaced along its optical axis O2, an illumination field diaphragm 46 and a further lens 48. After passing through the transport optics 42, the measuring light beam 34 falls onto a dichroic beam splitter 50 which reflects light in the infrared wavelength range while transmitting light in the visible range. The measuring light beam 34 is reflected in the direction of the object lens 12 by the dichroic mirror 50. The measuring light beam 34 reflected on the dichroic mirror 50 extends with a parallel offset to the optical axis O3 of the object lens 12. In this way, the measuring light beam 34 is guided into a partial region of an entry pupil 52 of the object lens 12 which is offset laterally with respect to the optical axis O3 of the object lens 12 and thus with respect to the center of the entry pupil 52 (cf. FIG. 4). The entry pupil 52 of the object lens 12 is thus backlit decentrally, which leads to the measuring light beam 34 being directed at an angle a obliquely to the optical axis O3 into the sample compartment 14.

For the sake of simplicity, the embedding medium 26 and the immersion medium 28, which in the sample compartment 14 are adjacent to the coverslip 24 from opposite sides, are omitted from the representation in FIG. 2. The measuring light beam 34 guided into the sample compartment 14 with oblique incidence is, as explained in more detail below with reference to FIG. 4, reflected on the coverslip 24, as a result of which a reflection beam 54 is produced that is fed back into the object lens 12.

After passing through the object lens 12, the reflection light beam 54 falls onto the dichroic mirror 50 which directs the reflection light beam 54 into the transport optics 42. After passing through the transport optics 42, the reflection light beam 54 falls onto the deflection prism 40 which reflects the reflection light beam 54 onto detector optics 56. The detector optics 56 direct the reflection light beam 54 onto a spectral filter 58 which is permeable only to light in the infrared wavelength range and blocks scattered light in the vicinity of this wavelength range. The reflection light beam 54 transmitted by the spectral filter 58 is incident on a position sensitive detector 60 capable of detecting the intensity of the reflection light beam 54 in a spatially resolved manner.

For the sake of completeness, FIG. 2 also illustrates the coupling of the tube 18 to the device 30 realized via the dichroic mirror 50. Accordingly, the dichroic mirror 50 in the present exemplary embodiment also serves to supply visible detection light 62, which is used for the actual microscopic imaging and guides the object lens 12 from the sample compartment 14 in the direction of the dichroic mirror 50, to the tube 18 by transmission.

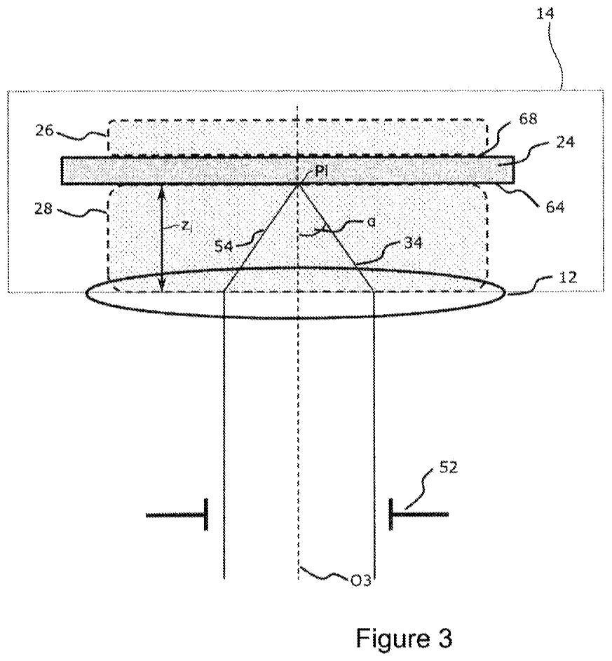

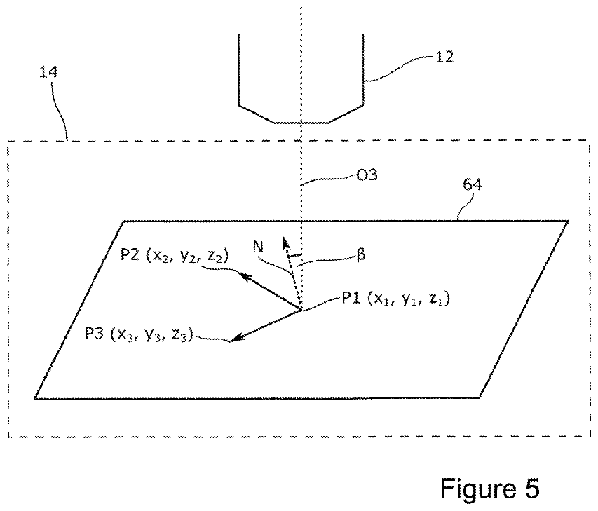

It is further explained with reference to FIGS. 3 to 6 how a tilting of the coverslip 24 relative to the optical axis O3 of the object lens 12 is determined by means of a distance measurement at three measuring points P1, P2 and P3 (cf. FIG. 5) according to the method according to the invention.

In FIG. 3, it is first illustrated how the reflection light beam 54 for each of the measuring points P1 to P3 is generated by reflection of the measuring light beam 34 which is used according to the invention to determine the distance of the respective measuring point from the object lens 12. In FIG. 3, the measuring point under consideration is denoted by Pi and the associated distance along the optical axis O3 of the object lens 12 by zi (i=1, 2, 3).

In accordance with FIG. 3, the measuring light beam 34 which backlights the entry pupil 52 of the object lens 12 in a decentralized manner is directed through the object lens 12 obliquely to the optical axis O3 to the front surface of the coverslip 24 facing the object lens 12 and designated 64 in FIG. 3 at an angle a. Since the coverslip 24 and the immersion medium 28 bordering its front surface 64 have different refractive indices, the front surface 64 of the coverslip 24 and the immersion medium 28 adjacent to it form a boundary surface on which the incident measuring light beam 34 is partially reflected. The part of the measuring light beam 34 reflected at this boundary surface generates the reflection light beam 54 which is guided back into the object lens 12.

FIG. 4 shows an intensity distribution V that generates the reflection light beam 54 on the position sensitive detector 60. In this case, the abscissa of the diagram according to FIG. 4 represents the incidence position on the detector 60 and the ordinate represents the intensity measured at the respective incidence position. The intensity distribution V according to FIG. 4 shows a peak P whose position Xi, which can be determined on the position-sensitive detector 60 with reference to a reference position Xref, is a measure for the distance zi which the surface 64 of the coverslip 24 has along the optical axis O3 of the object lens 12.

In the schematic representation according to FIG. 5 it is illustrated that the three measuring points P1, P2 and P3 are defined according to the invention such that they span a plane whose tilting reflects the tilting of the front surface 64 relative to the optical axis O3 of the object lens 12 to be determined. Each of the measuring points P1, P2 and P3 is defined by three coordinates (xi, yi, zi) (i=1, 2, 3). In this case, the coordinates xi, yi are predetermined, while the coordinate zi, which indicates the distance of the associated measuring point Pi from the object lens, depicts the parameters to be determined according to the invention. In the example of FIG. 5, the optical axis O3 of the object lens 12 is aligned with the measuring point P1 which means that in this example the distance of the point P1 is determined. If the distance determinations for the two other measuring points P2 and P3 are to be carried out, they are to be approached accordingly. For this purpose, for example, the coverslip 24 and the object lens 12 are moved relative to one another transversely to the optical axis O3 thereof until the optical axis O3 is set to the desired measuring point P2 or P3. Further shown in FIG. 5 is a normal vector N which is perpendicular to the plane defined by the measuring points P1, P2 and P3. The normal vector N encloses an angle β with the optical axis O3 of the object lens which indicates the tilting of the plane defined by the measuring points P1, P2 and P3 and thus of the front surface 64 of the coverslip 24.

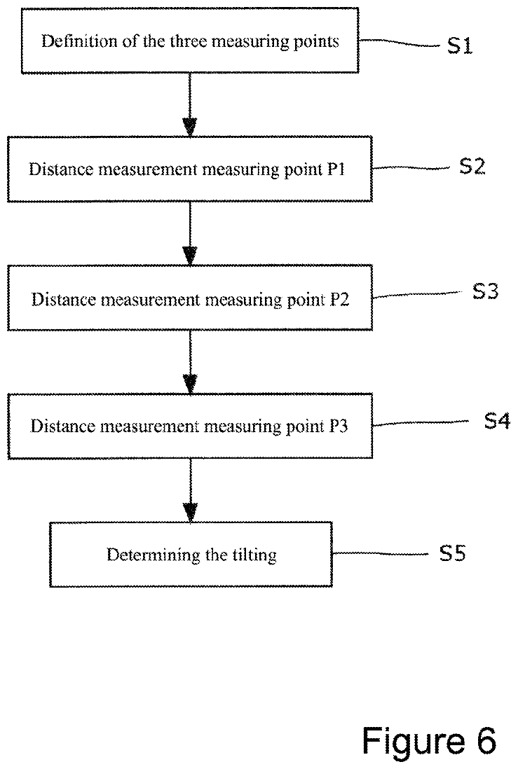

The flowchart of FIG. 6 shows an example of how the method for determining the tilt of the coverslip 24 can be implemented.

In a first step S1, the three measuring points P1, P2, P3 on the surface 64 of the coverslip 24 are defined in such a way that a plane which represents the surface 64 is defined by the points P1, P2 and P3 in accordance with FIG. 5.

In step S2, the first measuring point P1, if it is not already set anyway, is approached in such a way that the optical axis O3 of the object lens 12 is aligned with the first measuring point P1. As described above with reference to FIGS. 3 and 4, the distance z1 of the first measuring point P1 is measured by the object lens 12 along its optical axis O3.

In step S3, the second measuring point P2 is then approached by aligning the optical axis O3 of the object lens 12 with the measuring point P2 and the distance z2 which the second measuring point has from the object lens 12 is determined in the same way as for the first measuring point P1.

In step S4, the third measuring point P3 is approached by aligning the optical axis O3 of the object lens 12 with the third measuring point. Then, the distance z3 that the third measuring point P3 has from the object lens 12 is determined in the same manner as for the measuring points P1 and P2.

Then, in step S5, based on the distance measurements performed in steps S2, S3 and S4, the normal vector N which is perpendicular to the plane defined by the three measuring points P1, P2 and P3 is determined, and the angle β included by the normal vector N with the optical axis O3 of the object lens 12 is determined. The tilting of the surface 64 of the coverslip 12 is finally determined on the basis of the angle β.

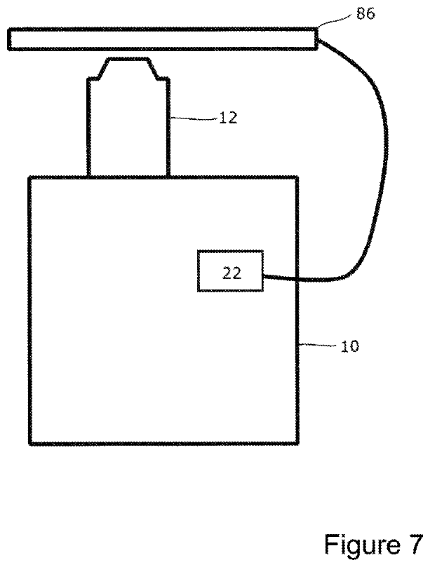

The different measuring points P1, P2 and P3 can take place, for example, by means of a microscope stage 86 which is shown purely schematically in FIG. 7. This can be adjusted transversely to the optical axis of the object lens 12 in order to carry out the desired distance measurements.

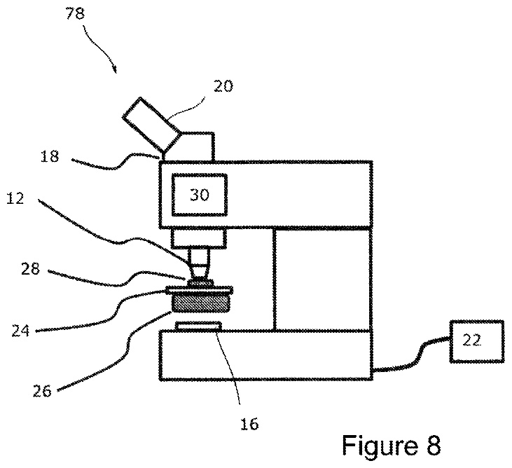

In contrast to the embodiment according to FIG. 1, in the microscope 78 shown in FIG. 8, the object lens 12 is arranged above the sample compartment 18 while the light source 16 is located below the sample compartment 18. Accordingly, the immersion medium 28, which is adjacent to the object lens 12 on the one hand and the coverslip 24 on the other hand, is located above the coverslip 24 while the embedding medium 26 is arranged below the coverslip 24.

The determining of the tilting of the coverslip 24 according to the invention takes place in the microscope 78 according to FIG. 8 in the same way as in the microscope 10 shown in FIG. 1.

The invention has been explained above with reference to specific exemplary embodiments. It goes without saying that the invention is not restricted to these exemplary embodiments and a number of modifications are possible.

Thus, in the example of FIG. 3, the measuring light beam 34 is partially reflected by the boundary surface formed by the front surface 64 of the coverslip 24 and the immersion medium 28 adjacent thereto. However, it is likewise possible for the measuring light beam 34 to be partially reflected by a boundary surface which is formed by a rear surface 68 of the coverslip 24 facing away from the object lens 12 and the embedding medium 26 adjacent thereto.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Microscope
12 Object lens
14 Sample compartment
16 Light source
18 Tube
20 Eyepiece
22 Control unit
24 Coverslip
26, 28 optical medium
30 Device
32 Light source
34 Measuring light beam
36 Illumination optics
38 Aperture diaphragm
40 Deflection prism
42 Transport optics
44 Focusing lens
46 Illumination field diaphragm
50 Beam splitter
52 Entry pupil
54 Reflection light beam
56 Detector optics
58 Spectral filter
60 Detector
62 Imaging beam path
64, 68 Surface
80, 82, 84 Measuring point
N Normal vector
O1, O2, O3 Optical axis
V1, V2 Vector
α, β Angle

1. A method for determining a tilting of a coverslip in a microscope which has an object lens facing the coverslip, the method comprising:
defining at least three measuring points which span a plane on a surface of the coverslip,
carrying out the following steps for each of the at least three measuring points:
directing a measuring light beam through the object lens to the respective measuring point,
producing a reflection light beam by reflecting the measuring light beam at least partially at the respective measuring point,
directing the reflection light beam through the object lens onto a position-sensitive sensor,
detecting an incidence position of the reflection light beam on the position-sensitive sensor, and
determining a distance of the respective measuring point from the object lens along an optical axis of the object lens based on the detected incidence position, and
determining, based on the determined distances, a tilting of the plane spanned by the at least three measuring points relative to the optical axis of the object lens as a tilting of the surface of the coverslip.

2. The method according to claim 1, wherein the at least three measuring points are defined by moving the coverslip and the object lens relative to one another transversely to the optical axis of the object lens.

3. The method according to claim 2, further comprising moving the coverslip relative to the object lens transversely to the optical axis of the object lens using a movable microscope stage.

4. The method according to claim 1, wherein the measuring light beam is guided into a partial region of an entry pupil of the object lens which is offset from the center of the entry pupil.

5. The method according to claim 1, wherein a measurement pattern is generated on the surface by the measuring light beam, and wherein the measurement pattern is imaged onto the position-sensitive sensor by the reflection light beam.

6. The method according to claim 5, wherein the measurement pattern imaged on the position-sensitive sensor is detected in the form of a spatial intensity distribution from which the incidence position of the reflection light beam is determined.

7. The method according to claim 1, wherein the surface of the coverslip on which the measuring light beam is reflected for generating the reflection light beam forms a partially reflecting boundary surface with an adjacent optical medium.

8. The method according to claim 7, wherein the optical medium is an embedding medium adjacent to the surface of the coverslip.

9. The method according to claim 1, wherein the orientation of a normal vector which lies perpendicular to the plane is determined based on the at least three measuring points, and wherein the tilting of the coverslip is determined therefrom.

10. The method according to claim 1, wherein more than three measuring points are defined, the distances of which are determined by the object lens in order to determine the tilting of the coverslip.

11. The method according to claim 1, further comprising adjusting the coverslip in order to compensate for the determined tilting.

12. A microscope, comprising:
a coverslip,
an object lens facing the coverslip, and
a device configured to determine a tilting of the coverslip by:
defining at least three measuring points which span a plane on a surface of the coverslip,
carrying out the following steps for each of the at least three measuring points:
directing a measuring light beam through the object lens to the measuring point,
producing a reflection light beam by reflecting the measuring light beam at least partially at the respective measuring point,
directing the reflection light beam through the object lens onto a position-sensitive sensor,
detecting an incidence position of the reflection light beam on the position-sensitive sensor, and
determining a distance of the respective measuring point from the object lens along its optical axis of the object lens based on the detected incidence position, and
determining a tilting of the plane spanned by the at least three measuring points relative to the optical axis of the object lens as a tilting of the surface of the coverslip based on the determined distances.

13. The microscope according to claim 12, wherein the device has an aperture diaphragm with an aperture opening which is arranged in a decentered manner at a distance from the optical axis of the object lens.

14. The microscope according to claim 12, wherein the device has a light source which emits the measuring light beam in the infrared wavelength range.

15. The microscope according to claim 12, wherein the position-sensitive sensor is a line sensor.
